(19) United States
(12) Patent Application Publication
(10) Pub. No.: US 2011/0049238 A1
(43) Pub. Date: Mar. 3, 2011

(54) TEST SYSTEM AND METHOD FOR TESTING PERFORMANCE OF A MULTI-CARD READER

(75) Inventors: JUN-MIN CHEN, Shenzhen City (CN); XIAO-GUANG YU, Shenzhen City (CN); CHAO-DONG PENG, Shenzhen City (CN); MING-SHIU OU YANG, Tu-Cheng (TW)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/824,227

(22) Filed: Jun. 28, 2010

(30) Foreign Application Priority Data
Aug. 31, 2009 (CN) 200910306379.8

(51) Int. Cl. G06K 7/00

(52) U.S. Cl. 235/438

(57) ABSTRACT

A test system and method for test performance of a multi-card reader includes identifying types of cards the multi-card reader can communicate with, obtaining a protocol of each type of card, and setting a protocol between the multi-card reader and the test system to one of the obtained protocols. Controlling the multi-card reader to read test data from a storage system of the test system and sending the read test data to the test system, testing performance of the multi-card reader by comparing the read test data with the test data stored in the storage system, to obtaining a test result according to the comparison.

### BACKGROUND

1. Field of the Disclosure

Embodiments of the present disclosure relate to test system and method, and particularly to a test system and method for testing the performance of a multi-card reader.

2. Description of Related Art

A multi-card reader is a device to communicate with multiple types of flash memory cards. Generally, for the purpose of ensuring the validity of data transferred by the multi-card reader, the performance of the card reader (e.g., the capabilities of a read-write function of the card reader) needs to be tested. Currently, testing is accomplished manually, which can result in the missing of testing some specific functions of the multi-card reader. Therefore, performance of the multi-card reader may not be assessed accurately.

### BRIEF DESCRIPTION OF THE DRAWINGS

FIG. 1 is a block diagram of one embodiment of a test system in communication with a multi-card reader.

FIG. 2 is a block diagram of one embodiment of the multi-card reader performance test system in the FIG. 1.

FIG. 3 is a flowchart of one embodiment of a method for testing performance of a multi-card reader using a test system.

### DETAILED DESCRIPTION

All of the processes described below may be embodied in, and fully automated via, functional code modules executed by one or more general purpose computers or processors. The code modules may be stored in any type of computer-readable medium or other computer storage device. Some or all of the methods may alternatively be embodied in specialized computer hardware.

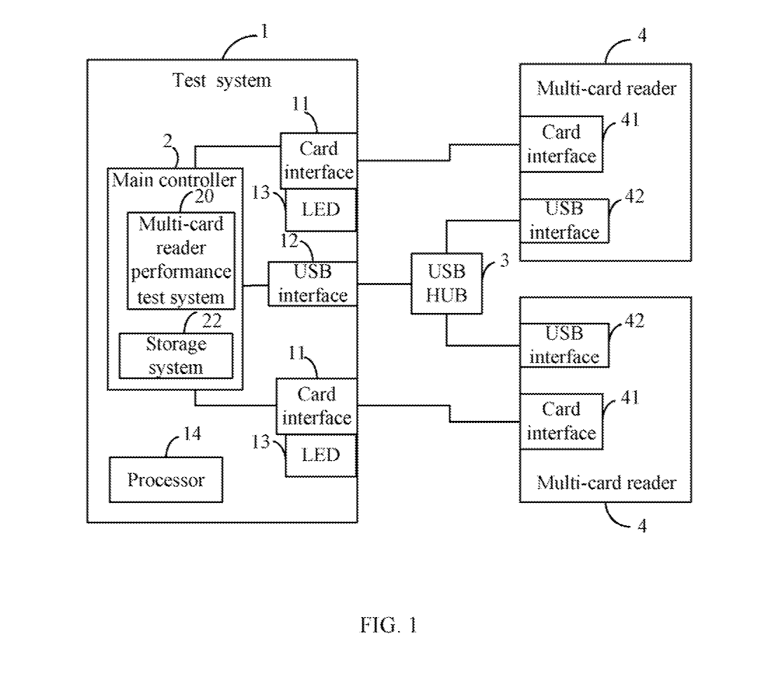

FIG. 1 is a block diagram of one embodiment of a test system 1 in communication with a multi-card reader 4. In one embodiment, the test system 1 includes a main controller 2, which includes a multi-card reader performance test system 20 and a storage system 22. The storage system 22 may be a hard disk drive, a random access memory, a read only memory, a cache system, or a combination of the aforementioned hardware. The storage system 22 may store various kinds of data, such as test data, for example.

The test system 1 further includes a plurality of card interfaces 11, a universal serial bus (USB) interface 12, and a plurality of light-emitting diodes (LEDs) 13. The multi-card reader 4 includes a card interface 41 and a USB interface 42. The USB interface 12 of the test system 1 communicates with the USB interface 42 of the multi-card reader 4 via a USB hub 3. Each of the plurality of card interfaces 11 of the test system 1 may communicate with the card interface 41 of the multi-card reader 4. The test system 1 and the multi-card reader 4 transmit data between the USB interface 12 and the USB interface 42 of the multi-card reader 4.

The multi-card reader performance test system 20 controls the multi-card reader 4 to read the test data from the storage system 22, tests performance of the multi-card reader 4 by comparing the read test data with the test data stored in the storage system 22, to obtain a test result.

The multi-card reader performance test system 20 controls the LED 13 to display a predetermined color according to the test result. For example, if the multi-card reader performance test system 20 determines that the performance of the multi-card reader 4 is acceptable, the LED 13 shines green. Otherwise, if the multi-card reader performance test system 20 determines that the multi-card reader 4 is unacceptable, the LED 13 shines red.

The test system 1 also includes a processor 14. The processor 14 executes one or more computerized operations of the test system 1 and other applications, to provide functions of the test system 1.

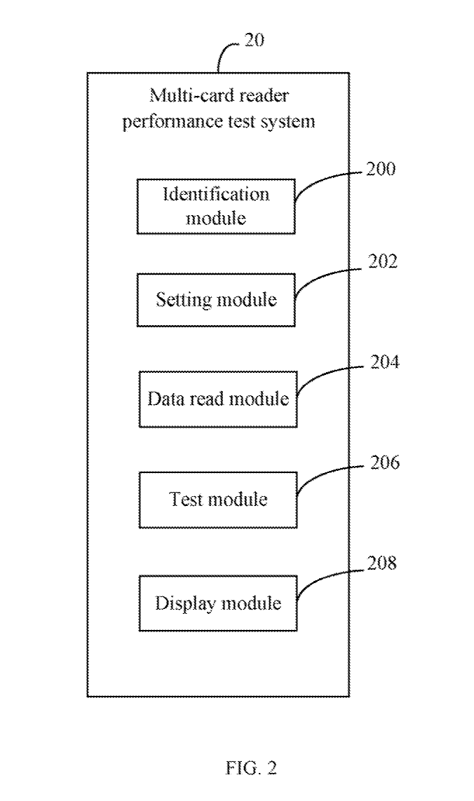

FIG. 2 is a block diagram of one embodiment of the multi-card reader performance test system 20 in the FIG. 1. In one embodiment, the multi-card reader performance test system 20 includes an identification module 200, a setting module 202, a data read module 204, a test module 206, and a display module 208. The modules 200, 202, 204, 206, and 208 may comprise one or more computerized codes to be executed by the processor 14 to perform one or more operations of the test system 1.

The identification module 200 identifies card types that the multi-card reader 4 can communicate with, and obtains a protocol of each card type. In one embodiment, the cards selected from the group consisting of smart media cards, secure digital cards, compact flash cards, multi-media cards, memory sticks, and extreme digital cards. The multi-card reader 4 may communicate with multiple card types. For example, the multi-card reader 4 may be able to communicate with both secure digital cards and the compact flash cards. Different cards work with different protocols, for example, the secure digital card use a secure digital card format protocol, and the compact flash card use a compact flash card format protocol.

The setting module 202 sets a protocol between the multi-card reader 4 and the test system 1 to one of the obtained protocols. For example, if the multi-card reader 4 can read data from the secure digital card and the compact flash card, the setting module 202 sets the protocol between the multi-card reader 4 and the test system 1 to the secure digital card protocol or the compact flash card protocol as needed.

The data read module 204 controls the multi-card reader 4 to read the test data from the storage system 22, and sends the read test data to the multi-card reader test system 1. In one embodiment, the test data may be a text file including random words.

The test module 206 tests the performance of the multi-card reader 4 by comparing the read test data and test data stored in the storage system 22, to obtain a test result according to the comparison. For example, if the read test data is the same as the test data stored in the storage system 22, the test module 206 determines that the multi-card reader 4 is acceptable. Otherwise, if the read test data is not the same as the test data stored in the storage system 22, the test module 206 determines that the multi-card reader 4 is unacceptable.

The display module 208 controls the LED 13 of the test system 1 to display a predetermined color according to the test result. For example, if the multi-card reader 4 is acceptable, the display module 208 controls the LED 13 to shines green, or if the multi-card reader 4 is unacceptable, the display module 208 controls the LED 13 to shine red.

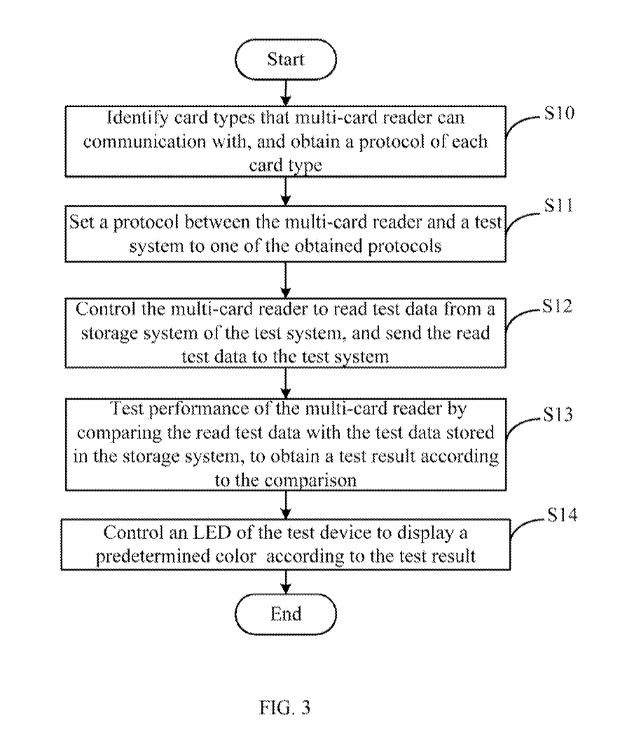

FIG. 3 is a flowchart of one embodiment of a method for test performance of a multi-card reader using a test system.

In block S10, the identification module 200 identifies card types the multi-card reader 4 can communicate with, and obtains a protocol of each type.

In block S11, the setting module 202 sets a protocol between the multi-card reader 4 and the test system 1 to one of the obtained protocols.

In block S12, the data read module 204 controls the multi-card reader 4 to read the test data from the storage system 22, and sends the read test data to the multi-card reader test system 1.

In block S13, the test module 206 tests performance of the multi-card reader 4 by comparing the read test data with the test data stored in the storage system 22, to obtain a test result according to the comparison. For example, if the read test data is the same as the test data stored in the storage system 22, the test module 206 determines that the multi-card reader 4 is acceptable. Otherwise, if the read test data is not the same as the test data stored in the storage system 22, the test module 206 determines that the multi-card reader 4 is unacceptable.

In block S14, the display module 208 controls the LED 13 of the test system 1 to display a predetermined color according to the test result. For example, if the multi-card reader 4 is acceptable, the display module 208 controls the LED 13 to shine green, or if the multi-card reader 4 is unacceptable, the display module 208 controls the LED 13 to shine red.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A test system for testing performance of a multi-card reader, the test system comprising:
a storage system to store test data;
at least one processor; and
one or more programs stored in the storage system and being executable by the at least one processor, the one or more programs comprising:
an identification module operable to identify card types that the multi-card reader can communicate with, and obtain a protocol of each card type;
a setting module operable to set a protocol between the multi-card reader and the test system to one of the obtained protocols;
a data read module operable to control the multi-card reader to read the test data from the storage system, and send the read test data to the test system; and
a test module operable to test performance of the multi-card reader by comparing the read test data with the test data stored in the storage system, to obtain a test result according to the comparison.

2. The test system of claim 1, further comprising a display module operable to control a light-emitting diode of the test system to display a predetermined color according to the test result.

3. The test system of claim 1, wherein the cards are selected from the group consisting of smart media cards, secure digital cards, compact flash cards, multi-media cards, memory sticks, and extreme digital cards.

4. The test system of claim 1, wherein the test module determines that the performance of the multi-card reader is acceptable if the read test data is the same as the test data stored in the storage system, or determines that the performance of the multi-card reader is unacceptable if the read test data is not the same as the test data stored in the storage system.

5. A method for test performance of a multi-card reader using a test system, the method comprising:
identifying card types that the multi-card reader can communicate with, and obtaining a protocol of each card type;
setting a protocol between the multi-card reader and the test system to one of the obtained protocols;
controlling the multi-card reader to read test data from a storage system of the test system and sending the read test data to the test system; and
testing performance of the multi-card reader by comparing the read test data with the test data stored in the storage system, to obtain a test result according to the comparison.

6. The method of claim 5, further comprising:
controlling a light-emitting diode of the test system to display a predetermined color according to the test result.

7. The method of claim 5, wherein the cards are selected from the group consisting of smart media cards, secure digital cards, compact flash cards, multi-media cards, memory sticks, and extreme digital cards.

8. The method of claim 5, wherein the performance of the multi-card reader is acceptable if the read test data is the same as the test data stored in the storage system, or the performance of the multi-card reader is unacceptable if the read test data is not the same as the test data stored in the storage system.

9. A computer readable medium having stored thereon instructions that, when executed by a processor, causes the processor to perform a method for test performance of a multi-card reader using a test system, the method comprising:
identifying card types that the multi-card reader can communicate with, and obtaining a protocol of each card type;
setting a protocol between the multi-card reader and the test system to one of the obtained protocols;
controlling the multi-card reader to read test data from a storage system of the test system and sending the read test data to the test system; and
testing performance of the multi-card reader by comparing the read test data with the test data stored in the storage system, to obtain a test result according to the comparison.

10. The medium of claim 9, wherein the method further comprises:
controlling a light-emitting diode of the test system to display a predetermined color according to the test result.

11. The medium of claim 9, wherein the cards are selected from the group consisting of smart media cards, secure digital cards, compact flash cards, multi-media cards, memory sticks, and extreme digital cards.

12. The medium of claim 9, wherein the performance of the multi-card reader is acceptable if the read test data is the same as the test data stored in the storage system, or the performance of the multi-card reader is unacceptable if the read test data is not the same as the test data stored in the storage system.
